(19) United States
(12) Patent Application Publication
(10) Pub. No.: US 2023/0273302 A1
(43) Pub. Date: Aug. 31, 2023

(54) METHOD AND APPARATUS FOR CORRECTING DISTANCE DISTORTION TO IMPROVE DETECTION ACCURACY OF LIDAR

(71) Applicant: HL KLEMOVE CORP., Incheon (KR)

(72) Inventors: Kimoon KANG, Gyeonggi-do (KR); Hyuk RYU, Seoul (KR); Yun Ki HAN, Gyeonggi-do (KR); Daegyeong KIM, Gyeonggi-do (KR); Yong Min PARK, Gyeonggi-do (KR)

(21) Appl. No.: 17/964,833

(22) Filed: Oct. 12, 2022

(30) Foreign Application Priority Data
Feb. 28, 2022 (KR) 10-2022-0025849
Feb. 28, 2022 (KR) 10-2022-0025853

(51) Int. Cl. G01S 7/497; G01S 17/89

(52) U.S. Cl. CPC G01S 7/497; G01S 17/89

(57) ABSTRACT

A method of correcting distance distortion to improve detection accuracy of a Light Detection and Ranging (LiDAR) according to one embodiment of the present disclosure includes acquiring measurement data for detecting a target by the LiDAR, estimating a range of a distance offset through comparison between the measurement data and reference data, estimating the distance offset based on a correlation coefficient between the measurement data and the reference data in the range of the distance offset, and correcting the measurement data using the estimated distance offset.

### CROSS-REFERENCE TO RELATED APPLICATION

This application claims priority to and the benefit of Korean Patent Applications No. 10-2022-0025853 and No. 10-2022-0025849, filed on Feb. 28, 2022, respectively, the disclosures of which are incorporated herein by reference in its entirety.

### BACKGROUND

### 1. Field of the Invention

The present disclosure relates to a method and apparatus for correcting distance distortion of a Light Detection and Ranging (LiDAR).

### 2. Discussion of Related Art

A Light Detection and Ranging (LiDAR) reception signal has a distance distortion that inevitably occur. For example, a delay due to a difference between a transmission trigger time and an actual ignition time in a transmitter of the LiDAR and a signal transmission delay after receiving a signal cause a distance offset in target detection. As another example, due to distance resolution present in a time-to-digital-converter (TDC) process, distortion occurs in which a plane appears as multiple truncated arcs.

The distance offset and the truncated arcs distort the plane into a curved surface, thereby causing inaccurate distance estimation. The distance distortion is a critical hindrance in LiDAR applications such as autonomous driving that requires accurate detection information of a target.

Meanwhile, the distance offset that occurs by the LiDAR has a deviation in the value for each channel even for data acquired from the same LiDAR. Accordingly, as well as distortion occurring in a single channel, distortion may occur in a plane with a large deviation in a vertical direction in a signal of multiple channels.

The truncated arc generated by the LiDAR has different forms depending on a vertical distance and a horizontal angle between a flat target and the LiDAR. Due to these characteristics that are affected by the distance and angle, distortion occurs that transforms the same plane into a different shape due to a change in the field of view (FOV) or distance due to movement of the LiDAR.

The present disclosure proposes a method of correcting a distance offset and a truncated arc in the distance distortion, and furthermore, a method of correcting the distance offset and the truncated arc which can correct not only single channel distortion but also multi-channel distortion.

### SUMMARY OF THE INVENTION

The present disclosure is directed to providing a method and apparatus for correcting a distance distortion that further improves the sensing performance of a LiDAR.

Also, the present disclosure is directed to providing a method and apparatus for correcting a distance distortion that corrects a distance offset and a truncated arc not only for a single channel but also for multiple channels.

According to an embodiment of the present disclosure, there is provided a method of correcting distance distortion to improve detection accuracy of a LiDAR, the method including: acquiring measurement data for detecting a target by the LiDAR; estimating a range of a distance offset through comparison between the measurement data and reference data; estimating the distance offset based on a correlation coefficient between the measurement data and the reference data in the range of the distance offset; and correcting the measurement data using the estimated distance offset.

The correcting of the measurement data may include correcting the measurement data acquired for each channel using the estimated distance offset for each channel.

The estimating of the range of the distance offset may include estimating the range of the distance offset using the reference data provided for each distance offset.

The estimating of the range of the distance offset may include identifying the range of the distance offset having the smallest difference in the distance offset between a specific pixel of the measurement data and a specific pixel of the reference data.

The estimating of the distance offset may include estimating the distance offset having the highest correlation coefficient between the measurement data and the reference data in the range of the distance offset.

The correcting of the measurement data may include correcting the measurement data by removing the estimated distance offset from the measurement data.

According to an embodiment of the present disclosure, there is provided an apparatus for correcting a distance distortion to improve detection accuracy of a LiDAR, the apparatus including a processor configured to acquire measurement data for detecting a target by the LiDAR, estimate a range of a distance offset through comparison between the measurement data and reference data, estimate the distance offset based on a correlation coefficient between the measurement data and the reference data in the range of the distance offset, and correct the measurement data using the estimated distance offset.

The processor may correct the measurement data acquired for each channel using the estimated distance offset for each channel.

The processor may estimate the range of the distance offset using the reference data provided for each distance offset.

The processor may identify the range of the distance offset having the smallest difference in the distance offset between a specific pixel of the measurement data and a specific pixel of the reference data.

The processor may estimate the distance offset having the highest correlation coefficient between the measurement data and the reference data in the range of the distance offset.

The processor may correct the measurement data by removing the estimated distance offset from the measurement data.

According to an embodiment of the present disclosure, there is provided a method of correcting a truncated arc to improve detection accuracy of a LiDAR, the method including: acquiring measurement data for detecting a target by the LiDAR; estimating a horizontal angle between the LiDAR and the target using the measurement data; identifying an error in the measurement data using an error map related to an error generated by a distance resolution of the LiDAR; and correcting the measurement data using the identified error.

The method may further include generating the error map by mapping the error for each coordinate within a detection area of the LiDAR.

The generating of the error map may include generating the error map for each horizontal angle between the LiDAR and the target.

The correcting of the measurement data may include correcting the measurement data for each pixel using the error identified for each pixel.

The estimating of the horizontal angle may include estimating the horizontal angle through a regression line calculated using linear regression from the measurement data.

According to an embodiment of the present disclosure, there is provided an apparatus for correcting a truncated arc to improve detection accuracy of a LiDAR, the apparatus including a processor configured to acquire measurement data for detecting a target by the LiDAR, estimate a horizontal angle between the LiDAR and the target using the measurement data, identify an error in the measurement data using an error map related to an error generated by a distance resolution of the LiDAR, and correct the measurement data using the identified error.

The processor may generate the error map by mapping the error for each coordinate within a detection area of the LiDAR.

The processor may generate the error map for each horizontal angle between the LiDAR and the target.

The processor may correct the measurement data for each pixel using the error identified for each pixel.

The processor may estimate the horizontal angle through a regression line calculated from the measurement data using linear regression.

The processor may calculate a regression line from the measurement data using the linear regression.

According to one embodiment of the present disclosure, it is possible to separately perform compressing a range of a distance offset using reference data and estimating an accurate distance offset using a correlation coefficient within the compressed range of the distance offset, thereby more precisely estimating the distance offset.

According to one embodiment of the present disclosure, it is possible to precisely estimate and correct a distance offset for each channel, thereby correcting all the pieces of measurement data more precisely.

According to one embodiment of the present disclosure, it is possible to estimate a final distance offset more quickly and with a low data throughput by compressing the range of the distance offset.

According to one embodiment of the present disclosure, it is possible to restore an accurate shape of a target through an error compensation for a truncated arc, thereby obtaining more accurate distance information.

According to one embodiment of the present disclosure, it is possible to precisely estimate an error for each channel and perform correction using the estimated error, thereby correcting all the pieces of measurement data more precisely.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram illustrating distortion due to a distance offset according to one embodiment of the present disclosure;

FIG. 2 is a diagram illustrating a bird-eye view and a front view of distance-distorted measurement data according to one embodiment of the present disclosure;

FIG. 3 is a block diagram illustrating the configuration of a LiDAR and a correction apparatus according to one embodiment of the present disclosure;

FIG. 4 is a diagram illustrating an operation flowchart of a correction apparatus for correcting a distance offset according to one embodiment of the present disclosure;

FIG. 5 is a diagram illustrating reference data and measurement data according to one embodiment of the present disclosure;

FIG. 6 is a diagram illustrating a state of estimating a range of a distance offset according to one embodiment of the present disclosure;

FIG. 7 is a diagram illustrating a state of estimating a distance offset according to one embodiment of the present disclosure;

FIG. 8 is a diagram illustrating a result of correcting measurement data for each channel;

FIG. 9 is a diagram illustrating distortion due to a truncated arc according to one embodiment of the present disclosure;

FIG. 10 is a diagram illustrating an operation flowchart of a correction apparatus for correcting truncated arc distortion according to one embodiment of the present disclosure;

FIG. 11 is a diagram illustrating a state of estimating a horizontal angle between a LiDAR and a target according to one embodiment of the present disclosure;

FIG. 12 is a diagram illustrating an error map according to one embodiment of the present disclosure;

FIG. 13 is a diagram illustrating a result of correcting measurement data for each channel; and

FIG. 14 is a diagram illustrating a result of correcting measurement data according to a horizontal angle between a LiDAR and a target.

### DETAILED DESCRIPTION OF EXEMPLARY EMBODIMENTS

Exemplary embodiments of the present disclosure will be described in detail below with reference to the accompanying drawings. While the present disclosure is shown and described in connection with exemplary embodiments thereof, it will be apparent to those skilled in the art that various modifications can be made without departing from the spirit and scope of the invention.

Hereinafter, an exemplary embodiment according to the present disclosure will be described in detail with reference to the accompanying drawings. The detailed description set forth below, in conjunction with the accompanying drawings, is intended to describe exemplary embodiments of the invention, and is not intended to represent the only embodiments in which the invention may be practiced. In order to clearly describe the present invention in the drawings, parts irrelevant to the description may be omitted, and the same reference numerals may be used for the same or similar elements throughout the specification.

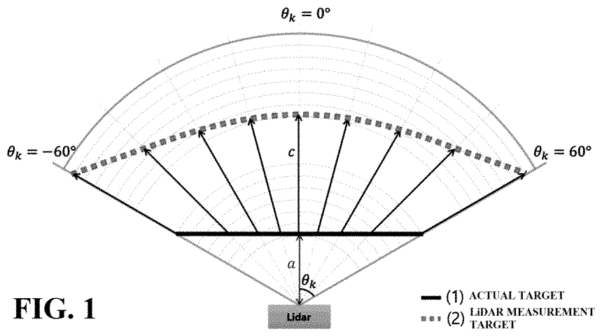

FIG. 1 is a diagram illustrating distortion due to a distance offset according to one embodiment of the present disclosure.

FIG. 1 illustrates distortion due to a distance offset that appears in a Light Detection and Ranging LiDAR reception signal according to one embodiment of the present disclosure. In FIG. 1, it is assumed that a LiDAR according to one embodiment of the present disclosure has a horizontal angle of view θₖ between −60 and 60 degrees and an actual target 1 is placed at a point indicated by a solid line having a vertical distance a to the LiDAR.

As described above, in measurement data of the LiDAR, distortion may occur due to a distance offset for various reasons, such as a delay due to a difference between a transmission trigger time and an actual ignition time in a transmitter of the LiDAR, a transmission delay of a signal after receiving the signal, and the like.

Accordingly, as indicated by a dotted line in FIG. 1, the LiDAR may acquire data (hereinafter, referred to as measurement data) of a measurement target 2 that is distorted by a distance offset c compared to the actual target 1.

In this case, the distance offset c is the same constant regardless of a pixel for a single channel. Accordingly, distortion correction may be performed by removing a distance offset ĉ estimated from a LiDAR signal received for each channel. Therefore, it is necessary to estimate the accurate distance offset ĉ for each channel.

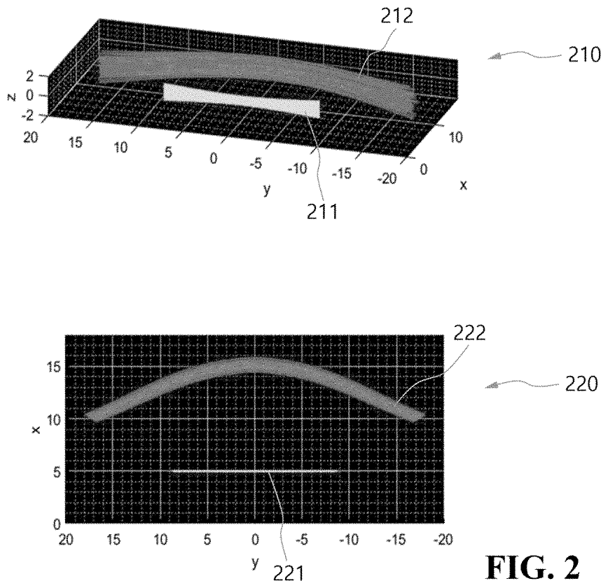

FIG. 2 is a diagram illustrating a bird-eye view 210 and a front view 220 of distance-distorted measurement data according to one embodiment of the present disclosure.

The bird-eye view 210 is a view shown in a direction looking at the ground from above on a point cloud, and a flat target 211 appears as a thicker and distorted curved target 212 farther than an actual location of the flat target 211 with respect to all channels.

It can be seen from the front view 220 that the flat target 221, which is the actual target, appears as the thicker and distorted curved target 222 farther than a point where the flat target 221 is actually located.

At this time, referring to the curved target 212 in detail, it can be seen that a plurality of pieces of measurement data formed in a horizontal direction overlap each other to form the entire data. That is, the measurement target 2 shown in FIG. 1 is measurement data performed on one channel, and the measurement data measured for each channel and shown for all channels is the curved target 212 of FIG. 2.

In the present disclosure, distance distortion may be reduced by not only estimating the distance offset for a single channel, but also correcting the entire measurement data by performing the estimation for each channel.

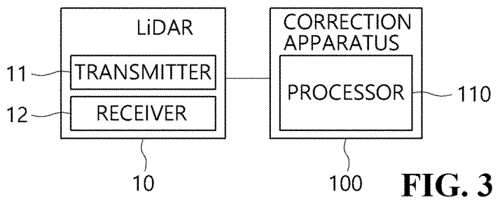

Hereinafter, a method and apparatus for performing the above-described method will be described in detail with reference to FIGS. 3 to 8.

FIG. 3 is a block diagram illustrating the configuration of a LiDAR and a correction apparatus according to one embodiment of the present disclosure.

Referring to FIG. 3, a LiDAR 10 according to one embodiment of the present disclosure includes a transmitter 11 and a receiver 12, and a correction apparatus 100 includes a processor 110.

According to one embodiment of the present disclosure, the LiDAR 10 is installed on the front and/or rear sides of a vehicle to detect a target existing within a driving radius of the vehicle. At this time, a position where the LiDAR 10 is installed, or the number of the installed LiDARs is not limited.

According to one embodiment of the present disclosure, the LiDAR 10 may irradiate an optical signal in a pulse form through the transmitter 11 and may receive reflected light reflected and returned from a target through the receiver 12, thereby calculating a distance to the target by measuring the time between a transmitted signal and a received signal. In this case, the LiDAR 10 may acquire measurement data for each channel by separating the signals received through the receiver 12 for each location. Although only the transmitter 11 and the receiver 12 are illustrated in FIG. 2, the LiDAR 10 may include a light source, a reflector, an electric motor for driving the reflector, a signal amplifier, a micro control unit (MCU), and a controller such as an electronic control unit (ECU).

According to one embodiment of the present disclosure, the correction apparatus 100 may receive measurement data measured by the LiDAR 10 to set a distance offset. In this case, when the distance offset is set in a mass production process of the LiDAR 10, the correction apparatus 100 may be implemented as a computer, a server, etc., as a separate apparatus from the LiDAR 10. In this case, in addition to the processor 110, the correction apparatus 100 may further include an input unit for receiving a user input, a communication unit for transmitting and receiving data to and from an external device such as the LiDAR 10, a display unit including a display screen, and a memory for storing data, an operation program, or the like.

However, the present disclosure is not limited thereto, and the LiDAR 10 itself may estimate the distance offset and correct the distorted measurement data. In this case, the correction apparatus 100 may be a microprocessor or a micro control unit (MCU) that is mounted and operated in the LiDAR 10, and may perform an overall operation of controlling the LiDAR 10.

According to one embodiment of the present disclosure, the correction apparatus 100 may receive the measurement data measured by the LiDAR 10 and may correct an error in the measurement data. The correction apparatus 100 may receive measurement data from the receiver 12 using a Controller Area Network (CAN) communication method, a Local Interconnect Network (LIN) communication method, or the like.

The processor 110 according to one embodiment of the present disclosure may control at least one other component (e.g., a hardware or software component) of the correction apparatus 100 by executing software such as a program, and may perform various data processing or operations.

The processor 110 according to one embodiment of the present disclosure may acquire measurement data for detecting a target by the LiDAR 10, estimate a range of a distance offset through comparison between the measurement data and reference data, estimate the distance offset based on a correlation coefficient between the measurement data and the reference data in the range of the distance offset, and correct the measurement data using the estimated distance offset.

The processor 110 according to one embodiment of the present disclosure may acquire measurement data for detecting a target by the LiDAR 10, estimate a horizontal angle between the LiDAR and the target using the measurement data, identify an error in the measurement data using an error map related to an error generated by a distance resolution of the LiDAR, and correct the measurement data using the identified error.

Meanwhile, at least part of data analysis, processing, and resultant information generation may be performed using at least one of a machine learning, neural network, or deep learning algorithm as a rule-based or artificial intelligence algorithm, in operations of acquiring measurement data for measuring a target by the LiDAR 10, estimating a range of a distance offset through comparison between the measurement data and reference data, estimating the distance offset based on a correlation coefficient between the measurement data and the reference data in the range of the distance offset, and correcting the measurement data using the estimated distance offset, or in operations of acquiring measurement data for detecting a target by the LiDAR 10, estimating a horizontal angle between the LiDAR and the target using the measurement data, identifying an error in the measurement data using an error map related to an error generated by a distance resolution of the LiDAR, and correcting the measurement data using the identified error. Examples of the neural network may include models such as a convolutional neural network (CNN), a deep neural network (DNN), and a recurrent neural network (RNN).

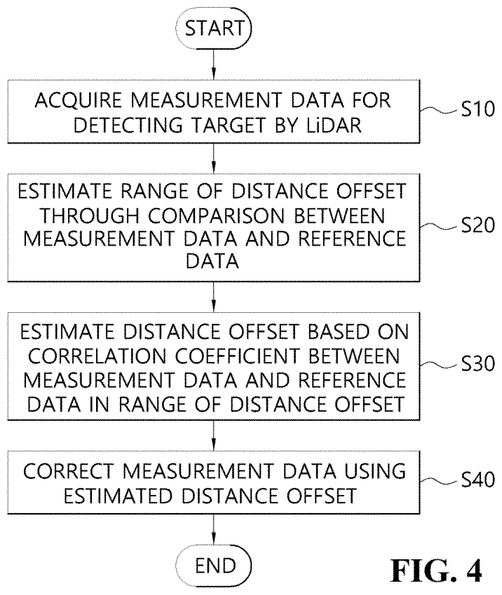

FIG. 4 is a diagram illustrating an operation flowchart of a correction apparatus according to one embodiment of the present disclosure.

According to one embodiment of the present disclosure, in operation S10, the processor 110 may acquire measurement data for detecting a target by the LiDAR 10.

In this case, it is assumed that the acquired measurement data is distorted data having a distance offset c. When the correction apparatus 100 is provided as an apparatus separate from the LiDAR 10, the correction apparatus 100 may receive the measurement data from the LiDAR 10 through a communication unit. Alternatively, when the correction apparatus 100 is provided in the LiDAR 10, the correction apparatus 100 may receive the measurement data from the receiver 12 using a CAN communication method, a LIN communication method, or the like.

According to one embodiment of the present disclosure, in operation S20, the processor 110 may estimate a range of a distance offset through comparison between the measurement data and reference data.

The reference data according to one embodiment of the present disclosure refers to distortion data that appears when the reference data has a specific distance offset from an exact location of a target.

According to the present disclosure, the reference data may be provided for each distance offset in order to estimate the range of the distance offset of the measurement data. For example, the reference data may be provided at an interval of 0.01 m from when the distance offset is 0.01 m to 10 m. However, the range of the distance offset of the reference data and the interval of the distance offset do not limit the present disclosure. In addition, the reference data may be provided by the processor 110 or pre-prepared reference data may be received from an external device.

The processor 110 may estimate the range of the distance offset having the smallest difference in the distance offset through comparison between the measurement data and the reference data. In this case, both the measurement data and the reference data use distance information on the polar coordinate system to estimate the distance offset.

More specifically, in order to estimate the range of the distance offset, the difference in the distance offset between the measurement data and the reference data may be utilized as in Equation 1.

dₙ=|r_{m,n}−r_{ref,n}|, [Equation 1]

where dₙ denotes a difference in distance offset between measurement data and reference data in pixel n, r_{m,n} denotes a distance between LiDAR and measurement data in pixel n, and r_{ref,n} denotes a distance between LiDAR and reference data in pixel n.

When the difference dₙ in the distance offset between the measurement data and the reference data is used, the distance offset of the measurement data may be known through the distance offset of the reference data having the smallest dn. Since the smaller the dₙ, the more similar the distance offset between the measurement data and the reference data, the distance offset of the measurement data may be estimated through the distance offset corresponding to the reference data having the smallest dₙ.

In the present disclosure, in order to estimate a more accurate distance offset, the range of the distance offset having a small difference dₙ of the distance offset is first compressed.

\hat{n}=argminₙ(dₙ) [Equation 2]

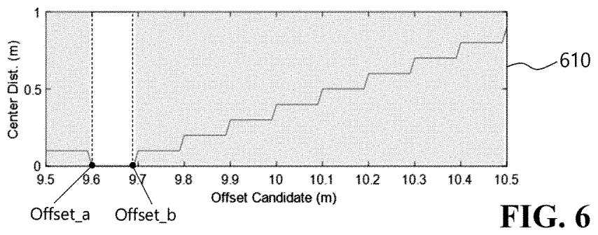

That is, the processor 110 may identify the range of the distance offset having the smallest difference of the distance offset between a specific pixel of the measurement data and a specific pixel of the reference data using Equation 2. More details will be described below with reference to FIG. 6.

According to one embodiment of the present disclosure, in operation S30, the processor 110 may estimate a distance offset ĉ based on a correlation coefficient between the measurement data and the reference data in the range of the distance offset.

In this case, the correlation coefficient refers to a relationship between a data aspect of the measurement data and a data aspect of the reference data. More specifically, the correlation coefficient represents a relationship of the increase of decrease trend between the reference data according to the increase or decrease trend of the measurement data and has a value between 0 and 1. As the value approaches 1, the data aspects of the measurement data and the reference data coincide with each other.

The correlation coefficient ρₙ may be determined by Equation 3 as follows.

$${ρ}_{\hat{n}} = \frac{{\sum }_{k = 1}^{1} ( {r}_{m} ( k ) - {\overline{r}}_{m} ) ( {r}_{ref , n} ( k ) - {\overline{r}}_{ref , n} )}{\sqrt{{\sum }_{k = 1}^{1} {( {r}_{m} ( k ) - {\overline{r}}_{m} )}^{2} {\sum }_{k = 1}^{l} {( {r}_{ref , n} ( k ) - {\overline{r}}_{ref , n} )}^{2}}} \qquad [ Equation 3 ]$$

According to one embodiment of the present disclosure, the processor 110 may estimate the distance offset having the highest correlation coefficient ρₙ as a final distance offset ĉ within the range of the distance offset compressed in operation S20.

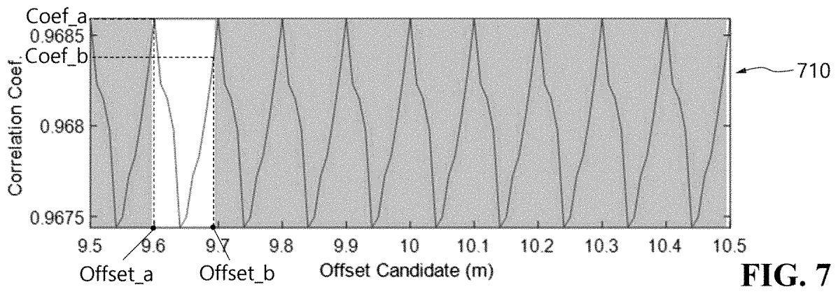

A state of estimating the final distance offset ĉ having the highest correlation coefficient will be described in detail below with reference to FIG. 7.

According to one embodiment of the present disclosure, in operation S40, the processor 110 may correct the measurement data using the estimated distance offset ĉ.

According to one embodiment of the present disclosure, as shown in Equation 4, the processor 110 may correct the measurement data by removing the distance offset ĉ estimated from the measurement data. In this case, the measurement data is corrected for each pixel and has the same distance offset within the same channel. Accordingly, the processor 110 may correct the measurement data by removing the same distance offset ĉ for the measurement data of all pixels in the same channel.

\hat{r}ₘ₌rₘ−ĉ, [Equation 4]

where \hat{r}ₘ denotes a corrected distance, rₘ denotes a distance between the LiDAR and measurement data, and ĉ denotes an estimated distance offset.

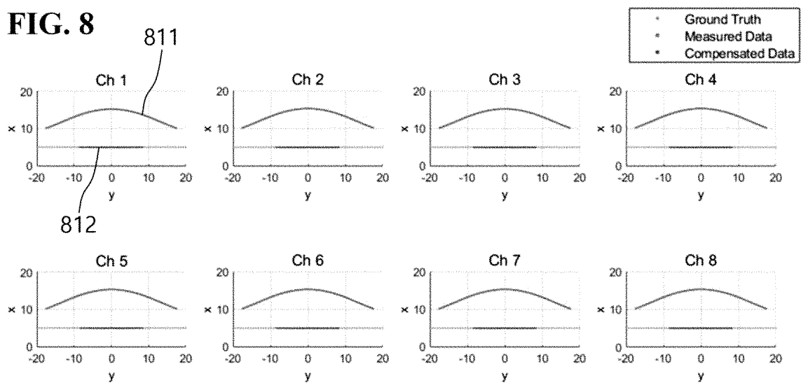

In addition, the processor 110 may correct the measurement data acquired for each channel using the estimated distance offset for each channel. More details will be described below with reference to FIG. 8.

According to one embodiment of the present disclosure, in a method of correcting distortion of the measurement data, compressing a range of a distance offset using the reference data and estimating an accurate distance offset using a correlation coefficient within the compressed range of the distance offset may be performed separately, thereby more precisely estimating the distance offset. In addition, the distance offset may be precisely estimated for each channel and correction may be performed using the estimated distance offset, thereby correcting the entire measurement data more precisely.

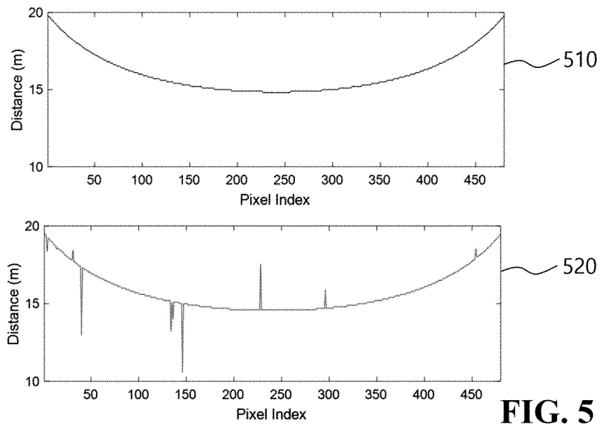

FIG. 5 is a diagram illustrating reference data and measurement data according to one embodiment of the present disclosure.

FIG. 5 shows reference data 510 and measurement data 520 described in operation S20 of FIG. 3. In the reference data 510 and the measurement data 520, a horizontal axis represents a pixel index, and a vertical axis represents a distance between the LiDAR and measurement data. That is, the distance between the LiDAR and the measurement data is indicated for each pixel. In this case, the pixel index refers to numbering the corresponding pixels from the left to the right of the measurement data of the LiDAR shown in FIG. 1.

Accordingly, referring to an approximate data aspect, it can be seen that the distance between the LiDAR and the measurement data becomes narrower toward the center of the measurement data.

At this time, although only one reference data 510 is displayed, in reality, a plurality of pieces of reference data 510 exist for each distance offset, and reference data 510 similar or identical to the measurement data 520 among the plurality of pieces of reference data 510 is identified. In this case, in order to more accurately estimate the final distance offset, in the present operation, the range of the distance offset is estimated based on the reference data 510 similar to the measurement data 520.

Accordingly, as the distance between the distance offsets decreases, the range of the distance offset may be more precisely estimated.

For example, as to the reference data, when the distance offset is provided at an interval of 0.001 m from 0.001 m to 10 m compared to when the distance offset is provided at an interval of 0.01 m from 0.01 m to 10 m, the range of the distance offset may be set in units of 0.001 m, thereby estimating the range of the distance offset more precisely.

FIG. 6 is a diagram illustrating a state of estimating a range of a distance offset according to one embodiment of the present disclosure.

The estimating of the range of the distance offset is performed by utilizing a difference in the distance offset between the reference data and the measurement data, as described above in operation S20 of FIG. 4.

In a graph 610 of FIG. 6, a horizontal axis represents a distance offset, and a vertical axis represents a difference in distance offset between the reference data and the measurement data.

Accordingly, the processor 110 may identify the range of the distance offset having the smallest difference between a specific pixel of the measurement data and a specific pixel of the reference data. In this case, the specific pixel may be a pixel located at the center in a single channel. However, the present disclosure is not limited thereto, and the difference in the distance offset between the specific pixel of the measurement data and the specific pixel of the reference data may be calculated for all pixels and an average value of the calculated differences may be used in various manners.

That is, the processor 110 may identify the range of the distance offset having the smallest difference in the distance offset between the measurement data and the reference data.

Referring to FIG. 6, the difference in the distance offset was calculated for a case where the distance offset of the reference data was between 9.5 m and 10.5 m.

The difference in the distance offset was identified as the smallest in a first distance offset offset_a and a second distance offset offset_b, and the processor 110 may estimate a range between the first distance offset offset_a and the second distance offset offset_b as the range of the distance offset.

According to one embodiment of the present disclosure, it is possible to estimate the final distance offset more quickly and with a low data throughput by compressing the range of the distance offset.

FIG. 7 is a diagram illustrating a state of estimating a distance offset according to one embodiment of the present disclosure.

The final distance offset is estimated using the correlation coefficient as described in operation S30 of FIG. 4.

In a graph 710 of FIG. 7, a horizontal axis represents a distance offset, and a vertical axis represents a correlation coefficient between reference data and measurement data. In this case, since the graph 710 is data in the same situation as in FIG. 6, in FIGS. 6 and 7, the first distance offset offset_a and the second distance offset offset_b have the same value. In addition, as described with reference to FIG. 6, the range of the distance offset is compressed into the first distance offset offset_a and the second distance offset offset_b. In order to further reduce the data throughput, the correlation coefficient may be identified only within the compressed range of the distance offset.

The correlation coefficient is calculated using Equation 4 as described above, and as a result, referring to the graph 710, it can be seen that the first distance offset offset_a has the largest correlation coefficient Coef_a in the range of the distance offset.

The processor 110 may calculate the correlation coefficient and estimate the first distance offset offset_a corresponding to the first correlation coefficient Coef_a having the largest correlation coefficient as the final distance offset.

FIG. 8 is a diagram illustrating a result of correcting measurement data for each channel.

FIG. 8 shows distorted measurement data from channel 1 (Ch 1) to channel 8 (Ch 8) and data compensating for the distorted measurement.

According to one embodiment of the present disclosure, as described with reference to operation S40 of FIG. 4, the processor 110 may correct the measurement data using the estimated distance offset ĉ. The processor 110 may correct the measurement data by removing the estimated distance offset ĉ from the measurement data.

Representatively, referring to the data on channel 1 (Ch 1) of FIG. 8, corrected data 812 obtained by correcting measurement data 811 using a distortion correction method according to the present disclosure is shown.

The processor 110 may correct the measurement data acquired for each channel using the estimated distance offset for each channel.

According to one embodiment of the present disclosure, it is possible to accurately correct the entire measurement data by correcting the distance offset for each channel.

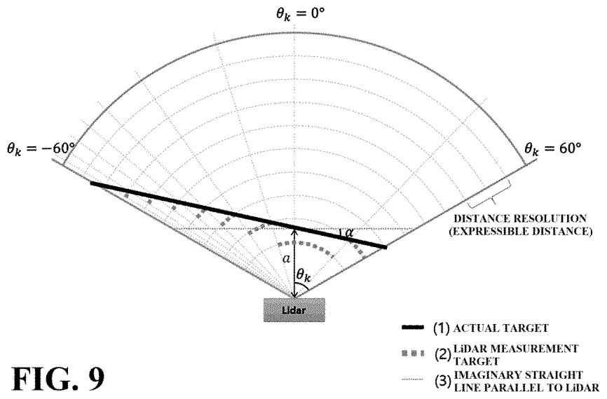

FIG. 9 is a diagram illustrating distortion due to a truncated arc according to one embodiment of the present disclosure.

FIG. 9 shows distortion due to a truncated arc that appears in a LiDAR reception signal according to one embodiment of the present disclosure. In FIG. 9, it is assumed that the LiDAR according to one embodiment of the present disclosure has a horizontal angle of view θₖ between −60 and 60 degrees, and an actual target 1 is placed at a point indicated by a solid line with a vertical distance a to the LiDAR on a plane where the horizontal angle between the LiDAR and the target is α.

As described above, in the measurement data of the LiDAR, distortion may occur in which the plane appears as multiple truncated arcs due to the distance resolution present in a time-to-digital-converter (TDC) process.

Unlike the actual target 1, the LiDAR may acquire data (hereinafter, referred to as measurement data) of the measurement target 2 composed of the truncated arcs as indicated by a dotted line in FIG. 9.

More specifically, as to the received signal of the LiDAR, data measured from the direction and distance where the actual target 1 is located is received, but in a process of expressing the received data according to the distance resolution of the LiDAR, all values within a predetermined distance are converted to the same distance due to the limitation of the distance resolution. That is, the measurement data is displayed with an error, and the data having such an error is gathered and displayed as several truncated arcs.

For example, when the resolution of the distance that the LiDAR can express is 0.1 m, decimal places less than 0.1 cannot be expressed in the distance resolution of the LiDAR, so that the resolution is expressed as 0.1 m even if 0.11 m is obtained. Therefore, in this case, an error by 0.01 m occurs, and the measurement data is gathered and displayed in the form of several truncated arcs.

At this time, the error according to the distance resolution is different for each pixel and is also different according to the horizontal angle between the target and the LiDAR.

In this way, unlike the actual target 1, the LiDAR may acquire data (hereinafter, referred to as measurement data) of the measurement target 2 composed of truncated arcs as indicated by the dotted line in FIG. 9.

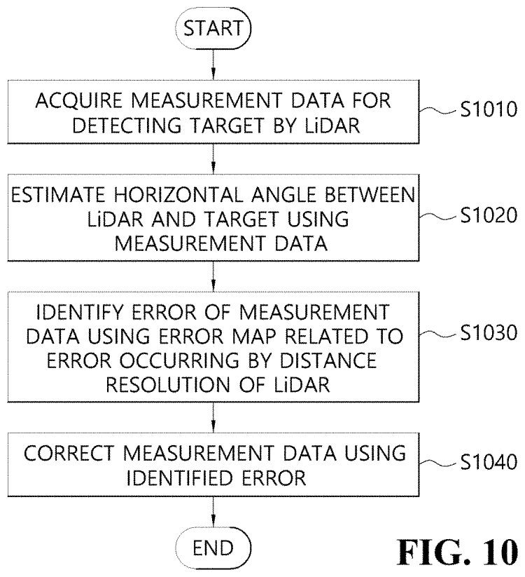

Hereinafter, a method and apparatus for correcting measurement data using information on an error according to distance resolution will be described in detail with reference to FIGS. 10 to 14. In this case, the configuration and function of the LiDAR 10 and the correction apparatus 100 that perform the above method adopts the contents described above in FIG. 3.

FIG. 10 is a diagram illustrating an operation flowchart of a correction apparatus for correcting truncated arc distortion according to one embodiment of the present disclosure.

According to one embodiment of the present disclosure, in operation S1010, the processor 110 may acquire measurement data for detecting a target by the LiDAR 10.

In this case, it is assumed that the acquired measurement data is distorted data according to the limitation of the distance resolution. When the correction apparatus 100 is provided as an apparatus separate from the LiDAR 10, the measurement data may be received from the LiDAR 10 through a communication unit. Alternatively, when the correction apparatus 100 is provided in the LiDAR 10, the measurement data may be received using a CAN communication method, a LIN communication method, or the like.

According to one embodiment of the present disclosure, in operation S1020, the processor 110 may estimate a horizontal angle α (hereinafter also referred to as an angle α) between the LiDAR and the target using the measurement data.

According to one embodiment of the present disclosure, the angle a refers to an angle between a plane on which the LiDAR is placed and a plane on which the target is placed. The angle α is a factor necessary for calculating an error caused by the distance resolution of the LiDAR, which will be described below, and the processor 110 may use linear regression to estimate the angle α.

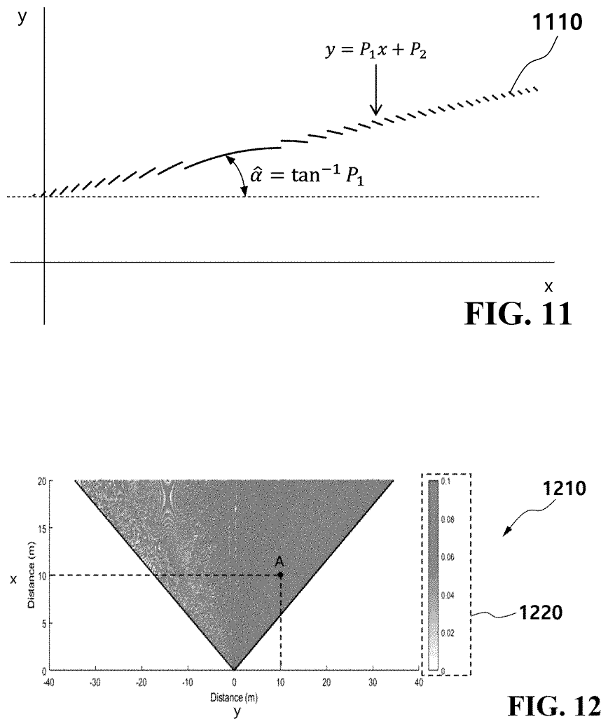

Using the linear regression, a regression line representing an arbitrary data cluster may be extracted. Accordingly, as shown in FIG. 11, the processor 110 may extract an equation (y=P₁x+P₂) of a straight line representing the measurement data from the measurement data. The processor 110 may estimate a horizontal angle \hat{α} between the LiDAR and the target using an inclination of the extracted straight line as in Equation 5. More details will be described below with reference to FIG. 11.

\hat{α}=tan⁻¹P₁, [Equation 5]

where \hat{α} denotes a horizontal angle between the LiDAR and the target, and P₁ denotes an inclination of a regression line of measurement data.

According to one embodiment of the present disclosure, in operation S1030, the processor 110 may identify an error in the measurement data using an error map related to an error generated by the distance resolution of the LiDAR.

According to one embodiment of the present disclosure, the error generated by the distance resolution of the LiDAR refers to an error that occurs when all values within a predetermined distance are converted to the same distance due to the limitation of the distance resolution, as described above.

The error map according to one embodiment of the present disclosure refers to information obtained by calculating errors generated by the distance resolution for each pixel. In fact, the error map may consist of vector information on a specific pixel and an error corresponding to the pixel, or may be provided in a table.

According to one embodiment of the present disclosure, the error may be calculated using Equations 6 to 8 below.

$${r}_{k} = \frac{a cos α}{cos ( {θ}_{k} + α )} , \qquad [ Equation 6 ]$$

where rₖ denotes a theoretical distance between the target and the LiDAR, θₖ denotes a horizontal angle of view of the LiDAR, α denotes a horizontal angle between the LiDAR and the target, and a denotes a vertical distance between the target and the LiDAR.

$${\tilde{r}}_{k} = {r}_{r e s} ⌊ \frac{{r}_{k}}{{r}_{res}} ⌋ , \qquad [ Equation 7 ]$$

where \tilde{r}ₖ denotes a distance with distortion between the target and the LiDAR, rᵣₑₛ denotes a distance resolution of the LiDAR, and nₖ denotes a theoretical distance between the target and the LiDAR.

$$ε = {r}_{k} - {\tilde{r}}_{k} = \frac{a cos α}{cos ( {θ}_{k} + α )} - {r}_{r e s} ⌊ \frac{a cos α}{{r}_{res} cos ( {θ}_{k} + α )} ⌋ , \qquad [ Equation 8 ]$$

where ε denotes an error caused by the distance resolution.

Referring to above Equations, Equation 6 indicates a distance rₖ between the target and the LiDAR which can be theoretically obtained using the horizontal angle of view θₖ of the LiDAR, the horizontal angle α between the LiDAR and the target, and the vertical distance a between the target and the LiDAR. The distance rₖ is actually included in the received signal of the LiDAR, and may be a measurement distance before distortion.

When distortion occurs in data due to the distance resolution rᵣₑₛ of the LiDAR, a distance \tilde{r}ₖ including the distortion between the target and the LiDAR may be obtained through Equation 7.

In addition, the error ε generated by the distance resolution can be obtained using a difference between the distance rₖ and the distance \tilde{r}ₖ calculated through Equations 6 and 7, respectively. This is as shown in Equation 8.

The processor 110 according to one embodiment of the present disclosure may generate an error map by mapping an error for each coordinate within a detection area of the LiDAR 10. The detection area refers to an area within a radius of the horizontal angle of view θₖ. More specifically, the processor 110 may generate an error map by calculating the errors c for each pixel. In this case, the processor 110 may generate the error map for each horizontal angle a between the LiDAR 10 and the target.

According to one embodiment of the present disclosure, in operation S1040, the processor 110 may correct the measurement data using the identified error ε.

According to one embodiment of the present disclosure, the processor 110 may correct the measurement data by adding the estimated error ε to the distance \tilde{r}ₖ including distortion as shown in Equation 9.

\hat{r}ₖ\tilde{r}ₖ+ε, [Equation 9]

where \hat{r}ₖ denotes a corrected distance, \tilde{r}ₖ denotes a distance including distortion between the target and the LiDAR, and ε denotes an error caused by the distance resolution.

At this time, the measurement data is corrected for each pixel, and is corrected using the same error map at the same angle α. Accordingly, the processor 110 may correct the measurement data by removing errors from the measurement data of all pixels.

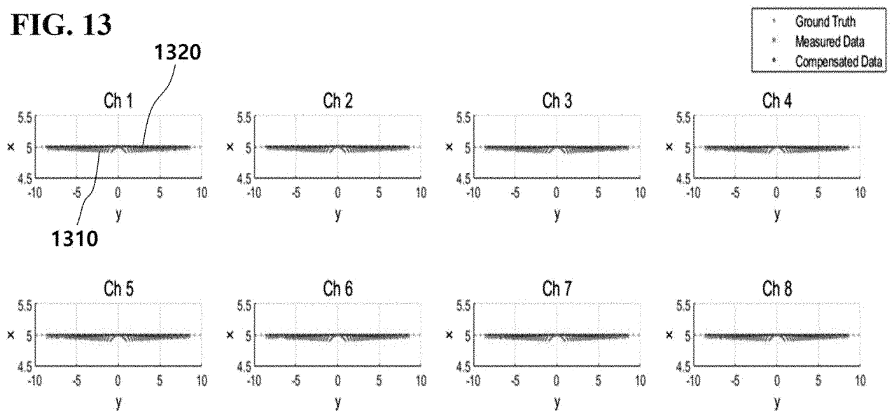

In addition, the processor 110 may correct the measurement data acquired for each channel using the estimated error for each channel. More details will be described below with reference to FIG. 13.

According to one embodiment of the present disclosure, an accurate shape of the target may be restored through error compensation for the truncated arc, and more accurate distance information may be obtained. In addition, the error may be precisely estimated for each channel, and correction may be performed using the estimated error, thereby precisely correcting all the pieces of measurement data.

FIG. 11 is a diagram illustrating a state of estimating a horizontal angle between a LiDAR and a target according to one embodiment of the present disclosure.

FIG. 11 shows measurement data 1110 including distortion due to distance resolution. The processor 110 according to one embodiment of the present disclosure may estimate a horizontal angle through a regression line calculated from the measurement data 1110 using linear regression. In this case, the processor 110 may calculate the regression line from the measurement data 1110 using the linear regression.

Referring to FIG. 11, the regression line calculated from the measurement data 1110 is calculated as y=P₁x+P₂. In this case, the horizontal angle α refers to an angle between a plane on which the LiDAR is placed and a plane on which the target is placed, and may be obtained using an inclination P₁ of the regression line.

The processor 110 may estimate the horizontal angle \hat{α} using Equation 5 described in relation to operation S1020 of FIG. 10.

The processor 110 may calculate an error caused by the distance resolution using the estimated angle \hat{α} as described above.

FIG. 12 is a diagram illustrating an error map according to one embodiment of the present disclosure.

FIG. 12 shows an example of an error map created using Equation 9. Since the error map is created for each estimated angle \hat{α}, a different type of error map is created when the angle \hat{α} is changed.

An error map 1210 shown in FIG. 12 is created based on a detection area according to the horizontal angle of view of FIG. 9, and it can be seen that the detection area of FIG. 9 and the area of the error map correspond to each other.

In the error map 1210 shown in FIG. 12, an error value for each pixel in the detection area is indicated by color. An error value 1220 according to one embodiment of the present disclosure has a value between 0 and 0.1, and a color corresponds to each value. In this case, the range of the error value or the color corresponding to each error value is not limited to the present embodiment.

Accordingly, the error map 1210 displays the color corresponding to the error value 1220 to correspond to the coordinate plane. For example, the color corresponding to the error value 1220 is displayed at a point A having a coordinate of (10, 10) on the coordinate plane.

The error map of the present disclosure refers to information on an error according to the distance resolution, the error map 1210 according to the present embodiment is a method of displaying the information on the error, and the present disclosure is not limited thereto.

According to one embodiment of the present disclosure, by expressing the error according to the error map in color, it is possible to more intuitively identify the degree of an error, a deviation of the error for each pixel, or the like.

FIG. 13 is a diagram illustrating a result of correcting measurement data for each channel.

FIG. 13 shows distorted measurement data from channel 1 (Ch 1) to channel 8 (Ch 8) and data compensating for the distorted measurement data.

According to one embodiment of the present disclosure, as described with reference to operation S1040 of FIG. 10, the processor 110 may correct measurement data using an estimated error ε. The processor 110 may correct the measurement data by removing the estimated error ε from the measurement data.

Representatively, referring to the data on channel 1 (Ch 1) of FIG. 13, corrected data 1320 obtained by correcting measurement data 1310 using the distortion correction method according to the present disclosure is shown.

The processor 110 may correct the measurement data acquired for each channel using the estimated error c for each channel. According to one embodiment of the present disclosure, it can be confirmed that a linear component of a measured target is recovered after error compensation through an error map in an individual channel.

According to one embodiment of the present disclosure, accurate correction of all the pieces of measurement data is possible by correcting an error for each channel.

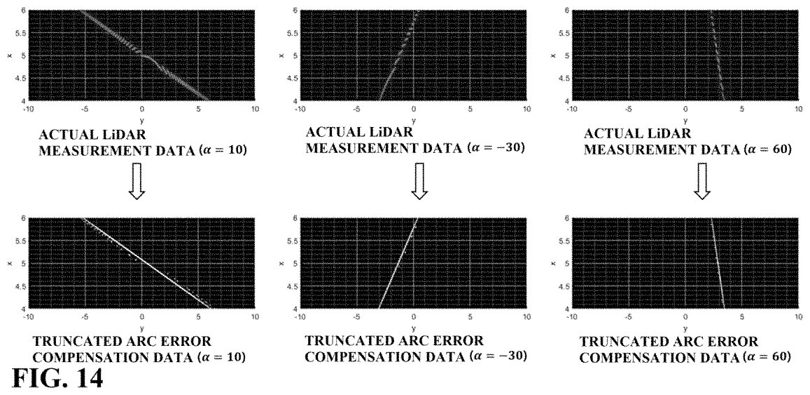

FIG. 14 is a diagram illustrating a result of correcting measurement data according to a horizontal angle between a LiDAR and a target.

FIG. 14 is a result of compensating for an error of a truncated arc with respect to a target of various angles. That is, in FIG. 14, it can be confirmed that a plane is restored regardless of a horizontal angle even when there is the horizontal angle between the LiDAR and the target.

What is claimed is:

1. A method of correcting distance distortion to improve detection accuracy of a Light Detection and Ranging (LiDAR), the method comprising:
acquiring measurement data for detecting a target by the LiDAR;
estimating a range of a distance offset through comparison between the measurement data and reference data;
estimating the distance offset based on a correlation coefficient between the measurement data and the reference data in the range of the distance offset; and
correcting the measurement data using the estimated distance offset.

2. The method of claim 1, wherein the correcting of the measurement data includes correcting the measurement data acquired for each channel using the estimated distance offset for each channel.

3. The method of claim 1, wherein the estimating of the range of the distance offset includes estimating the range of the distance offset using the reference data provided for each distance offset.

4. The method of claim 3, wherein the estimating of the range of the distance offset includes identifying the range of the distance offset having the smallest difference in the distance offset between a specific pixel of the measurement data and a specific pixel of the reference data.

5. The method of claim 1, wherein the estimating of the distance offset includes estimating the distance offset having the highest correlation coefficient between the measurement data and the reference data in the range of the distance offset.

6. The method of claim 1, wherein the correcting of the measurement data includes correcting the measurement data by removing the estimated distance offset from the measurement data.

7. The method of claim 1, further comprising:
estimating a horizontal angle between the LiDAR and the target using the measurement data;
identifying an error in the measurement data using an error map related to an error generated by a distance resolution of the LiDAR; and
correcting the measurement data using the identified error.

8. The method of claim 7, further comprising generating the error map by mapping the error for each coordinate within a detection area of the LiDAR.

9. The method of claim 8, wherein the generating of the error map includes generating the error map for each horizontal angle between the LiDAR and the target.

10. The method of claim 7, wherein the correcting of the measurement data includes correcting the measurement data for each pixel using the error identified for each pixel.

11. The method of claim 7, wherein the estimating of the horizontal angle includes estimating the horizontal angle through a regression line calculated using linear regression from the measurement data.

12. An apparatus for correcting distance distortion to improve detection accuracy of a Light Detection and Ranging (LiDAR), the apparatus comprising a processor configured to:
acquire measurement data for detecting a target by the LiDAR;
estimate a range of a distance offset through comparison between the measurement data and reference data;
estimate the distance offset based on a correlation coefficient between the measurement data and the reference data in the range of the distance offset; and
correct the measurement data using the estimated distance offset.

13. The apparatus of claim 12, wherein the processor corrects the measurement data acquired for each channel using the estimated distance offset for each channel.

14. The apparatus of claim 12, wherein the processor estimates the range of the distance offset using the reference data provided for each distance offset.

15. The apparatus of claim 14, wherein the processor identifies the range of the distance offset having the smallest difference in the distance offset between a specific pixel of the measurement data and a specific pixel of the reference data.

16. The apparatus of claim 12, wherein the processor estimates the distance offset having the highest correlation coefficient between the measurement data and the reference data in the range of the distance offset.

17. The apparatus of claim 12, wherein the processor corrects the measurement data by removing the estimated distance offset from the measurement data.

18. The apparatus of claim 12, wherein the processor
estimates a horizontal angle between the LiDAR and the target using the measurement data,
identifies an error in the measurement data using an error map related to an error generated by a distance resolution of the LiDAR, and
corrects the measurement data using the identified error.

19. The apparatus of claim 18, wherein the processor generates the error map for each horizontal angle between the LiDAR and the target by mapping the error for each coordinate within a detection area of the LiDAR.

20. The apparatus of claim 18, wherein the processor corrects the measurement data for each pixel using the error identified for each pixel.
